(19) United States
(12) Patent Application Publication
(10) Pub. No.: US 2006/0048065 A1
(43) Pub. Date: Mar. 2, 2006

(54) Event handling system

(76) Inventors: Wen-Sen Tang, Taipei (TW); Yu-Jen Chen, Taipei (TW)

Correspondence Address: G. LINK CO., LTD., Suite 137, PmB 174, 931 West 75th Street, Naperville, IL, 60565, US

(21) Appl. No.: 10/932,118

(22) Filed: Sep. 2, 2004

(51) Int. Cl. G06F 17/00

(52) U.S. Cl. 715/764; 715/765

(57) ABSTRACT

The present invention is an event handling system executed in a computer with a Windows operating system. Event setup codes are used to setup which system events and application events are needed to be monitored, and to setup to use one of colors of a full-color notifying light corresponding to the event when the events occur. A notifier manager is used to detect monitored system events and application events and to send a command to notifier interface codes. A notifier connected to the computer comprises: a full-color notifying light and a firmware. The notifier executes the firmware and makes a light emit light of a color corresponding to the event. The notifier interface codes are used as a device driver of the notifier which receives the command sent by the notifier manager and sends the command to the notifier.

### FIELD OF THE INVENTION

The present invention relates to a monitoring system executed in a computer, and particularly to monitoring events that may occur in the computer and using an instruction of light of full colors to represent one of the events, whereby the user knows what has just happened in the computer by seeing different colors of light on the monitor.

### BACKGROUND OF THE INVENTION

In the prior art, when an event has happened in a computer working on a Windows operating system, such as the receipt of e-mail, a popup message screen appears to indicate the arrival of the e-mail or the user can open an e-mail window application to view whether e-mail has arrived. In either case, the user has to focus on messages displayed on the screen to know whether an event has occurred.

The inventor of the present invention wanted to improve the shortcomings of the prior art and has used different colors of light to individually indicate each event occurring so the user immediately knows which event has just happened in the computer by seeing the indications of different colors of light on the monitor.

### SUMMARY OF THE INVENTION

The first objective of the present invention is to provide an event handling system that is executed in a computer. From the event handling system, the user can immediately know which event has just happened in the computer.

The second objective of the present invention is to use an indication of light of one color of full-colors so the user can immediately know which event just happened in the computer from the different colors of light.

The third object of the present invention is to provide using combinations of multiple single-color light so that the user can immediately know which event has just happened in the computer, judging from different combinations of light.

To achieve the above mentioned objectives of the present invention, the present invention provides an event handling system applied in a computer executing a Windows operating system which comprises: event setup codes being a man machine interface configured to setup which occurred in the system events and application events are needed to be monitored and to set up each occurred event using a corresponding color of a full-color notifying light when the events occurs; a notifier manager configured to detect the monitored system events of the Windows operating system, to detect the monitored application events of the applications, and to send a command to the notifier interface codes; a notifier electrically connected to the computer which comprises: the full-color notifying light; a firmware executed by the notifier, wherein the notifier executes the firmware to proceed with the following steps: receiving a command package sent by the notifier interface codes; making the full-color notifying light to emit light of the color specified by the command package; the notifier interface codes configured to be a device driver of the notifier, to receive the command sent by the notifier manager, and pack the command to the command package to send to the notifier.

### BRIEF DESCRIPTION OF DRAWINGS

The present invention can be more fully understood by reference to the following description and accompanying drawings, in which:

FIG. 1 shows an architectural diagram of an event handling system of the present invention;

FIG. 2 shows an executing screen of event setup codes of the present invention;

FIG. 3 shows an executing screen of setting a color of displaying a full-color notifying light;

FIG. 4 shows a data structure diagram of a command package of the present invention;

FIG. 5 shows a flow chart of a firmware of a notifier of the present invention; and

FIG. 6 shows a hardware circuit diagram of an embodiment of the notifier of the present invention.

### DETAILED DESCRIPTION OF THE INVENTION

An event handling system 10 of the present invention is mainly executed in a computer. When the computer executes a Windows operating system and all application programs, the computer also executes the event handling system 10. When a user operates the computer in a Windows operating environment, a series of events, such as receiving e-mail, will occur in the computer anytime some item in a work calendar should be done now, and so on. Through the event handling system 10 of the present invention, the user can know which events have happened. Besides, a full-color notifying light 473 of the event handling system 10 is used to remind the user.

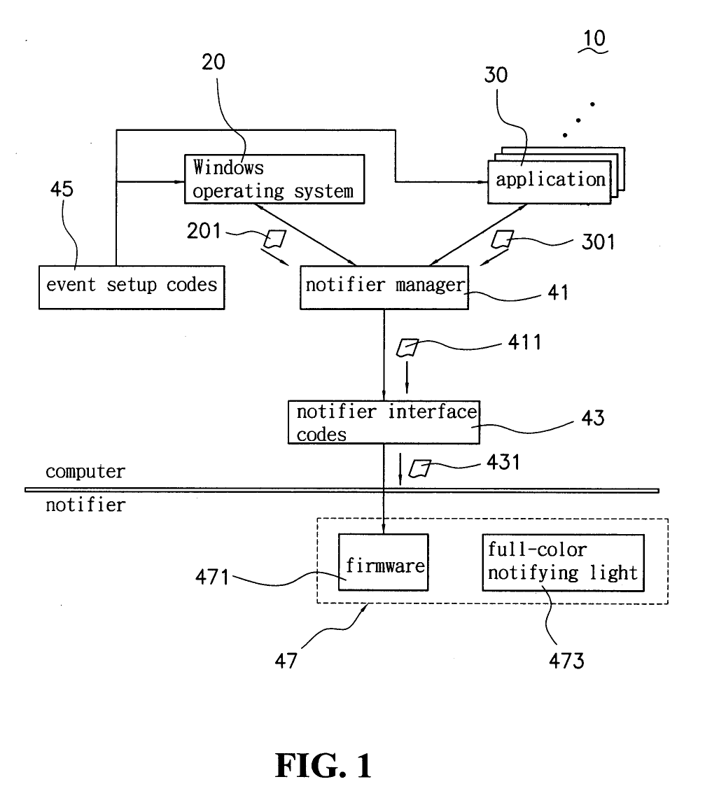

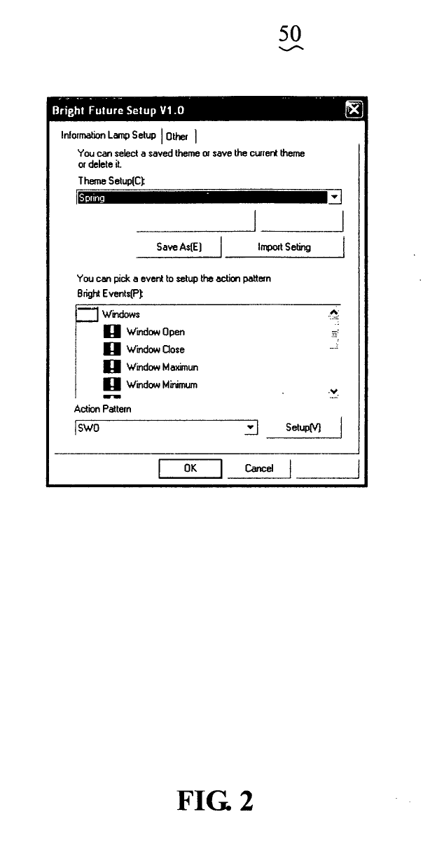

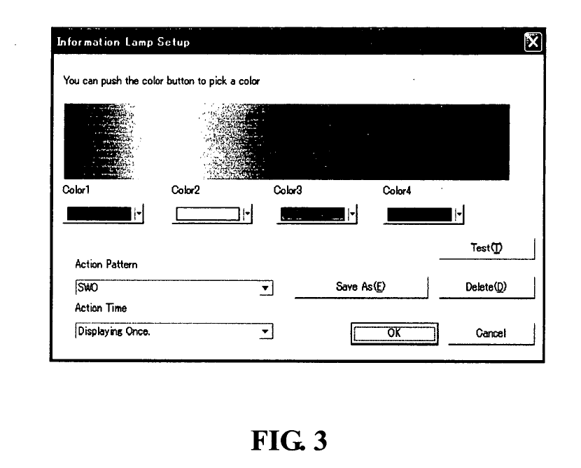

FIG. 1 shows an architectural diagram of the event handling system of the present invention. The event handling system 10 of the present invention mainly comprises: event setup codes 45, a notifier manager 41, notifier interface codes 43, and a notifier 47. The event setup codes 45 are mainly used as a man (users) machine (the event handling system 10) interface. Please refer to FIG. 2, showing an executing screen of the event setup codes of the present invention, and FIG. 3, showing an executing screen of setting a color of the full-color notifying light. The event setup codes 45 are used to setup which systems events and application events are needed to be monitored and to setup which color is represented as each event when the events occur. In FIG. 2, the user can use the operations of a window 50 to check or uncheck the system events and application events to decide whether they are monitored by the present invention. In FIG. 3, the user uses four colors to define one of the full colors representing the full-color notifying light 473 corresponding to occurred events.

The notifier manager 41 is used to detect monitored system events 201 of the Windows operating system 20, to detect monitored application events 301 of the applications 30, and to send a command 411 to the notifier interface codes 43. The implementation of the notifier manager 41 can be implied by referring to a system development kit provided by a vendor (e.g. Microsoft), for example, the notifier manager 41 is used as a resident code-type to be executed in the computer. The possible examples of the above mentioned monitored system events 201 are events of opening a window, closing a window, maximizing a window, minimizing a window, moving a window, changing a size of a window, etc. The possible examples of the above mentioned monitored application events 301 are events of notifying e-mails, notifying a calendar, entering an optical disc, and rejecting an optical disc. When the notifier manager 41 detects that the above mentioned events 201, 301 occur, it prepares a command 411 corresponding to the event immediately. Of course, the command 411 comprises data of color corresponding to the event, then the command 411 is sent to the notifier interface codes 43.

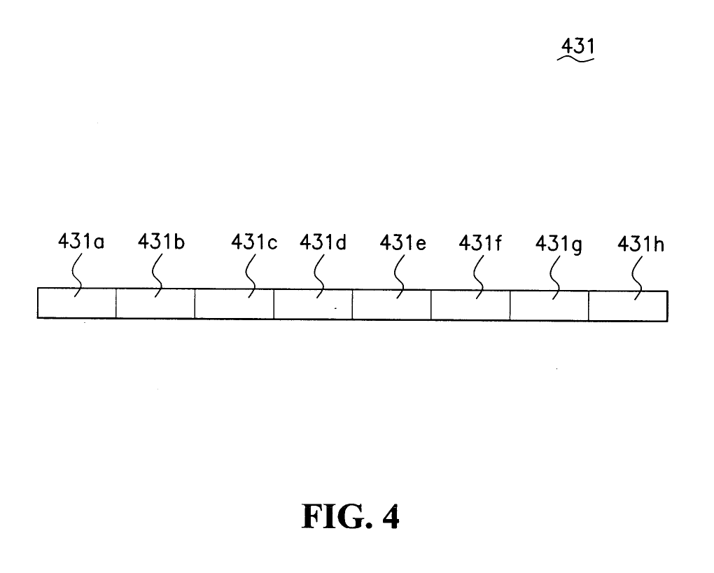

The notifier interface codes 43 are used to be a device driver of the notifier 47, to receive the command 411 sent by the notifier manager 41, and to pack the command 411 to a command package 431 to send to the notifier 47. FIG. 4 shows a data structure diagram of the command package of the present invention. Fields 431a, 431b, 431c, 431d are used to store one of the full colors set in FIG. 3, i.e. a value consisted of three single colors, red, green, and blue. For example, each field 431a, 431b, 431c, 431d are consisted of six bytes, and each single color uses two bytes to represent the composition of the color. Fields 431e, 431f, 431g, 431h are used to store shown time of the four colors, respectively. For example, each field 431e, 431f, 431g, 431h uses one byte to represent the time.

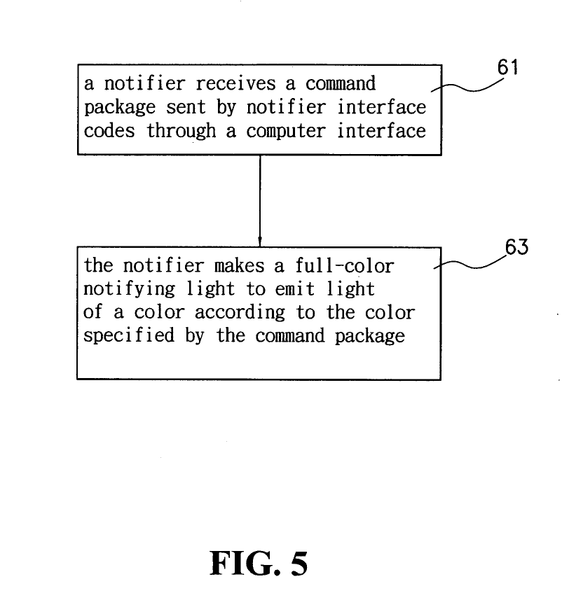

The notifier 47 is electrically connected to the computer and comprises: firmware 471 and full-color notifying light 473. The embodied elements of the notifying light 473 of the notifier 47 can use full-color light emitting diodes (LEDs). The firmware 471 is executed by a micro-controller (not shown) of the notifier 47, please refer to FIG. 5, showing a flow chart of the firmware of the notifier of the present invention. In step (61), the notifier 47 receives the command package 431 sent by the notifier interface codes 43 through an interface of the computer (e.g. USB interface). In step (63), the notifier 47 makes the full-color notifying light 473 to emit the light of the color according to the color specified by the command package 431.

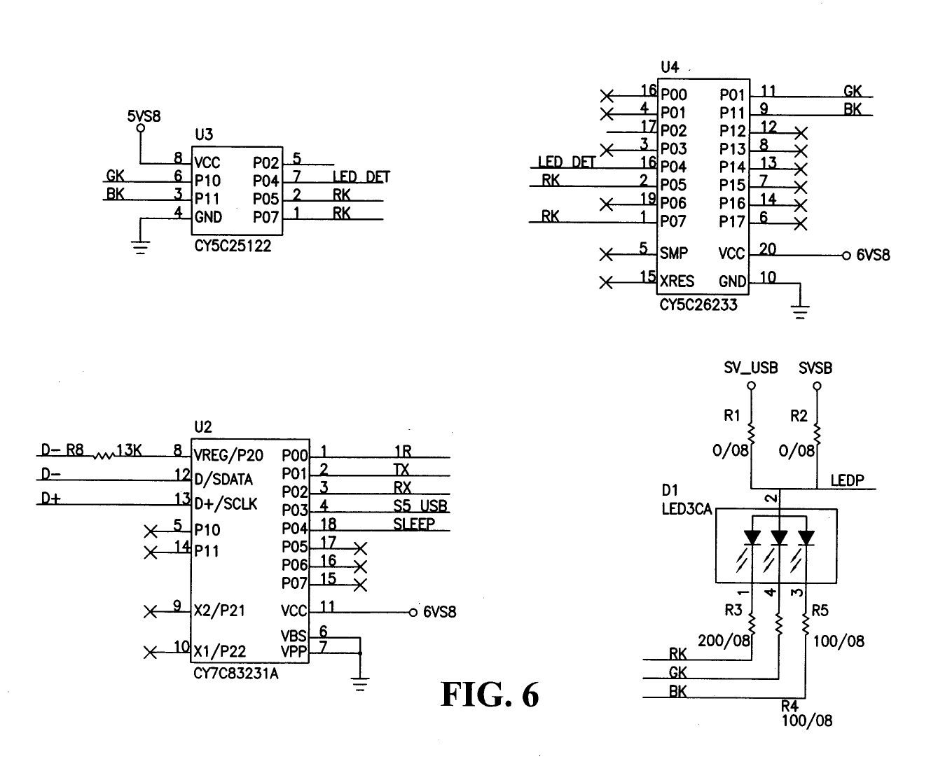

FIG. 6 shows a hardware circuit diagram of an embodiment of the notifier of the present invention. In FIG. 6, the notifier 47 uses a USB interface which can be implied by using USB related elements. In the hardware circuit of FIG. 6, the firmware 471 of the present invention is a built-in USB micro-controller.

The event handling system 10 of the present invention can let the user to set up event types to be monitored by himself and use the full-color notifying light 473 to show each color of light to indicate each event 201, 301. While the user operates the computer, he can immediately know which event happened from the different colors of light if the setup monitored event occurred. This is most convenient for the user of the present invention.

In the above disclosure of the present invention, the full-color notifying light is used to be the example. Persons skilled in the art can also use combinations of multiple single-color notifying lights. The change of the combinations of single-color lights can represent one of the events. This change is also in the scope of the present invention.

Persons skilled in the art should understand various other modifications can be made without departing from the spirit and scope of the invention. It is therefore intended to cover in the appended claims all such changes and modifications that are within the scope of the present invention.

What is claimed is:

1. An event handling system applied in a computer executing Windows operating system comprising:
event setup codes as a man machine interface configured to setup which system events have happened and which application events are needed to be monitored and to set up every event using a full-color notifying light corresponding to one of the colors when the events occur;
a notifier manager configured to detect monitored system events of the Windows operating system, to detect monitored application events of the applications, and to send a command to notifier interface codes;
a notifier electrically connected to the computer comprising;
the full-color notifying light;
a firmware executed by the notifier, wherein the notifier executes the firmware to proceed with the following steps:
receiving a command package sent by the notifier interface codes;
making the full-color notifying light to emit light of the color according to color specified by the command package;
notifier interface codes configured to be a device driver of the notifier, to receive the command sent by the notifier manager, and pack the command to a command package to send to the notifier.

2. The event handling system as claimed in claim 1, wherein the system events are events of opening a window, closing a window, maximizing a window, minimizing a window, moving a window, and changing a size of a window, respectively.

3. The event handling system as claimed in claim 1, wherein the application events are events of notifying an e-mail, notifying a calendar, entering an optical disk, and rejecting an optical disk, respectively.

4. The event handling system as claimed in claim 1, wherein the Windows operating system is a Microsoft Windows operating system.

5. The event handling system as claimed in claim 1, wherein the Windows operating system is a Linux Windows operating system.

6. The event handling system as claimed in claim 1, wherein the notifier is connected to a USB connecting interface of the computer.

7. The event handling system as claimed in claim 1, wherein the full-color notifying light is a full-color light emitting diode (LED).

8. The event handling system as claimed in claim 1, wherein the notifier manager uses a resident code type to be executed in the computer.

9. The event handling system as claimed in claim 1, wherein the full-color notifying light can be substituted by more than one single-color notifying lights.
